(19) United States
(12) Patent Application Publication
(10) Pub. No.: US 2018/0147700 A1
(43) Pub. Date: May 31, 2018

(54) Torque Transfer Driver

(71) Applicants: Eddie Tajudeen, Winter Springs, FL (US); Chad Tajudeen, Orlando, FL (US); Carissa Tajudeen, Orlando, FL (US)

(72) Inventors: Eddie Tajudeen, Winter Springs, FL (US); Chad Tajudeen, Orlando, FL (US); Carissa Tajudeen, Orlando, FL (US)

(21) Appl. No.: 15/484,563

(22) Filed: Apr. 11, 2017

Related U.S. Application Data
(60) Provisional application No. 62/497,744, filed on Nov. 30, 2016.

(51) Int. Cl. B25B 13/48; B25B 23/00; B25B 21/00

(52) U.S. Cl. CPC B25B 13/481; B25B 21/00; B25B 23/0035

(57) ABSTRACT

The present invention is a wrench type device designed to deliver high torque into awkward and cramp spaces. A long, slim, and narrow body harboring a plurality of band type components for transferring torque from one rotatable shank to another in line rotatable shank. The rotatable shanks positioned at both ends are identical and the device is fundamentally symmetric in all planes, thereby producing same functionality when the device is reversed or rotated centrally in all planes. The rotatable shank accepts and retains by utilizing magnetics, a variety of inserts designed to drive bolts, nuts, screws and the likes. The device is designed to be compatible with devices in the current tool market, hence activation of the rotatable shanks can originate from manually or powered tools and its driving abilities can be communicated to the aforementioned accessories such as socket tools, nut and screwdriver bits, torx, allen and the likes.

### CROSS REFERENCE TO RELATED APPLICATIONS

This non-provisional application filing is a continuation-in-part of a provisional application No. 62/497,744 filed on Nov. 30, 2016 which has a current confirmed status. The inventors hereby claim benefit under Title 35, United States Code, Section 119(e). It is also a continuation-in-part of several provisional applications filed during the past 20 years with acknowledgement that they have all exceeded their useful status.

### FEDERALLY SPONSORED RESEARCH AND DEVELOPMENT

Not applicable.

### FIELD OF THE INVENTION

The present invention relates to hand tools and more particularly a wrench type device that transfers very high torque continuously from one aperture to another in-line aperture by means of a specialized rotatable shank and band system within a highly compact housing. The device is intended to be an integral part of a mechanic's toolbox interfacing with other manual, powered, and supplementary tools and devices.

### BACKGROUND OF THE INVENTION

In the screw, bolt, nut, and overall fastener connection world there exist cramped and obstructive spaces whereby it becomes difficult for standard hand tools such as; a ratchet and socket, a box wrench, a ratcheting box wrench, and the likes to remove a fastening connection such as nuts, bolts, screws, and the likes. At times the access space is confined and narrows both horizontally and vertically. Even if the feat is achievable by a ratchet and socket combination or a box and open end combo wrench, getting the full ratcheting effect due to small rotating stroke becomes a tedious and painstaking task hence an ideal situation for the present invention. A critical requirement of a successful device is to have a means of delivering very high torque in a small footprint that is similar in dimension to a ratcheting box type wrench. A truly worthy device must produce at a minimum what is termed a fastener's “breaking torque”. The term “breaking torque” is applied to a properly torqued/tightened fastener. This breaking torque initiates the fastener removal without failure and then continues the device abilities to complete the full removal process without disengagement. In pursuance of the present invention, some of its development employing similar prior art techniques such as chains, the likes and gears proved to be inferior due to the fact that the designs could not deliver the equivalent torques in the same dimensional packaging. The present invention thus finalized a simpler and smart design whereby bringing down cost and delivering a highly scalable device for performance requirements. A list of analogous prior arts is provided to comparatively demonstrate the innovative and improved on abilities of the present invention.

### REFERENCES CITED

U.S. Patent Documents

| | | |
|---|---|---|
| 141,259 | 07/1873 | Bubser |
| 2,830,479 | 04/1958 | Finn |
| 3,138,983 | 01/1963 | Frizzell |
| 3,577,794 | 04/1971 | Kerfoot |
| 4,063,475 | 20/1977 | Perkins |
| 4,374,480 | 02/1983 | Diaz |
| 4,573,953 | 04/1986 | Tangorra |
| 5,269,856 | 12/1993 | Igawa et al |
| 5,461,949 | 10/1995 | Carver |
| 5,540,122 | 07/1996 | Lund |
| 5,540,123 | 07/1996 | Lund |
| 5,586,474 | 12/1996 | Lund |
| 5,927,156 | 27/1999 | Landwehr |
| 7,344,462 | 03/2008 | Lund |
| 8,979,689 | 03/2015 | Diert |

### SUMMARY OF THE INVENTION

The overall objective of the present invention is to eliminate all previous weaknesses incurred by similar prior arts involved in mechanical torque transfer. The inventor's research and development resulted in a hybrid device that can compete at least equally on ruggedness and exceed on many application abilities of the current ratcheting type hand tools. The essence of the present invention is only possible from the implementation of a very unique design idea to the torque transferring mechanism and process.

Another objective was to make the invention; low in cost, simple to mass produce, and performance scalable as with current tool design trends.

Another ensuing objective was to further develop the invention to be adaptable to current like market hand and power tools and their corresponding supplementary devices.

The device is a double aperture wrench type design composing a long slim body that contains a drivable hollowed center rotatable shank at each end of the lengthened body and a means for transferring torque from one rotating rotatable shank to the other in line rotatable shank. The rotatable shanks positioned at either ends are identical and the device is fundamentally symmetric in all plane, thereby producing same functionality when the device is reversed or rotated centrally in all planes. The rotatable shanks accept and retain a variety of inserts designed to drive bolts, nuts, screws and the likes. The rotatable shank's rotation can originate from manually or powered driven tools. The centered inner hollowed surfaces of the rotatable shank contain embedded magnets for retention of inserts. The mating surfaces of the rotatable shank and inserts are designed with specific geometry as to synchronize rotation of the inserts and handle large forces without failure. The geometry can vary however it must retain the essence of its purpose. The outer circumferential surface of the rotatable shank comprises a plurality of equally spaced radial protrusions. These protrusions will synchronously and geometrically fit into openings located on the torque transferring means and thus provide transfer of torque when either is mechanically rotated. The torque transferring means is a plurality of flexible endless band type components made of high tensile strength steel, stainless steel being the optimum choice. However many newer technologies related to higher strength metals and composite blends some metal and non-metal combinations can be implemented for future use. The determination for non-failure of endless band is an engineering determination based on design performance requirements. A plurality of endless bands in an encasing fashion is intended to multiply the tensile force hence the ability of producing high torque with very little size change whereby as many encasing bands can be used to meet a performance requirement. The design simplification of the device is another achievement towards mass production and a resulting low market cost for the present invention. The device and inserts can be configured to reach around obstacles such as making an L or S shape for torque transferring. During the development of the present invention it became obvious that the device can behave as a stand-alone tool with a variety of supplementary components that would rival the current Ratchet and Socket tool set, hence a set was proposed to which similar components of the present invention would carry out similar functions of the said Ratchet and Socket tool set. The present invention is also created to integrate with the aforementioned devices and other existing drivers such as screw, allen, torx, other driven end bits and the likes. The device ensuing magnetic ability to entrap a nut also adds to its functionality as a nut positioner to provide an easy thread starting installation means for a nut or bolt in a difficult space. Accordingly, it is to be understood that the embodiments of the invention herein described are merely illustrative of the application and principles of the invention and should not limit its useful possibilities.

### DESCRIPTION OF DRAWINGS

FIG. 1 is an exploded perspective view of the device.

FIG. 2 is a perspective view of the device with one side of housing removed.

FIG. 3 is a full front view of the device with an enlarged partial of one end.

FIG. 4 is a full top view of the device.

FIG. 5 is an enlarged perspective section view of rotatable shank area.

FIG. 6 is a partial front mid-sectional view of rotatable shank area.

FIG. 7 is a partial front view of rotatable shank area with open casing.

FIG. 8 is a perspective view of the rotatable shank.

FIG. 9 is a perspective view of the bushing.

FIG. 10 is a perspective partial section view of inversely operational device.

FIG. 11 is a perspective view of device in use.

FIG. 12 is a perspective view of inserts/adapters.

### DETAILED DESCRIPTION OF THE INVENTION

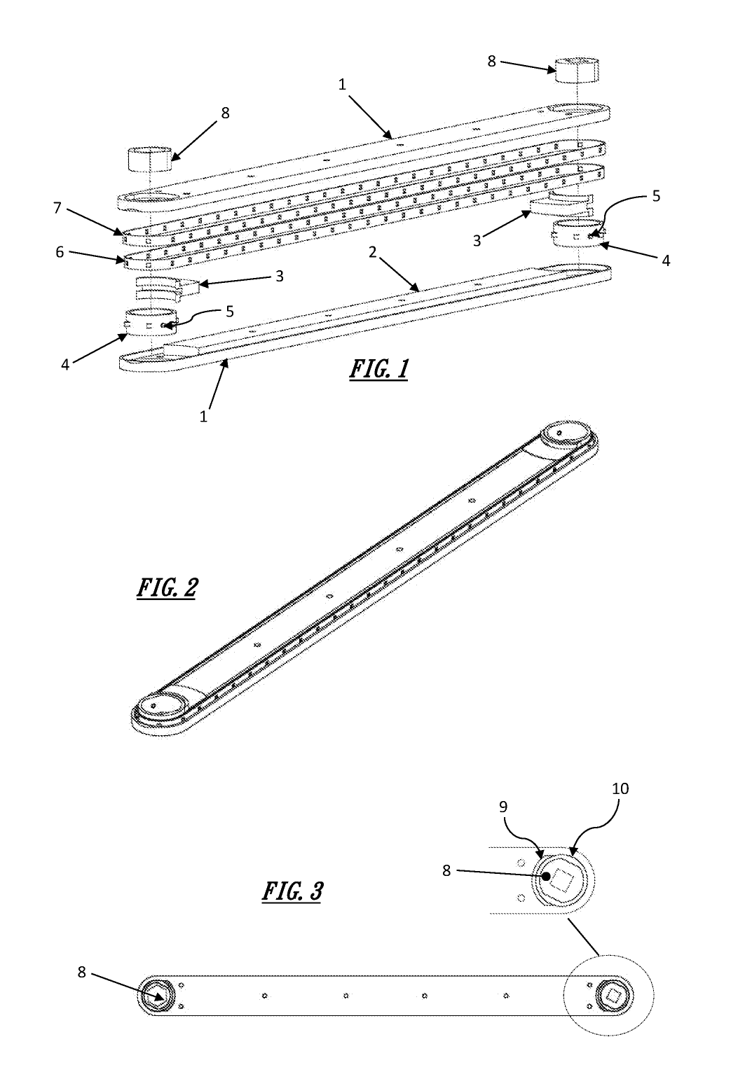

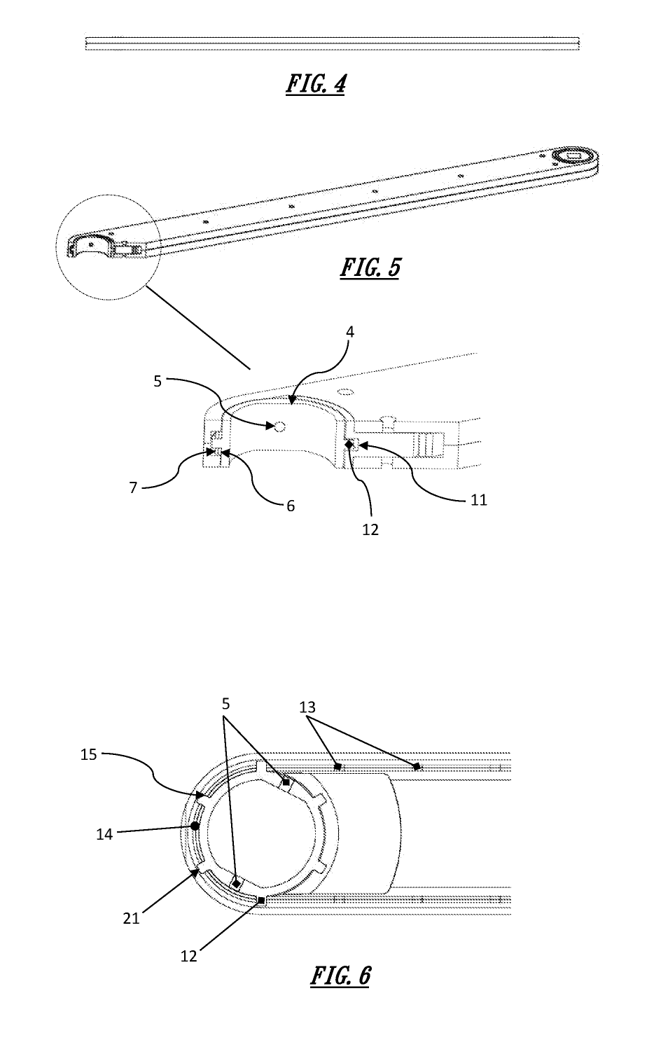

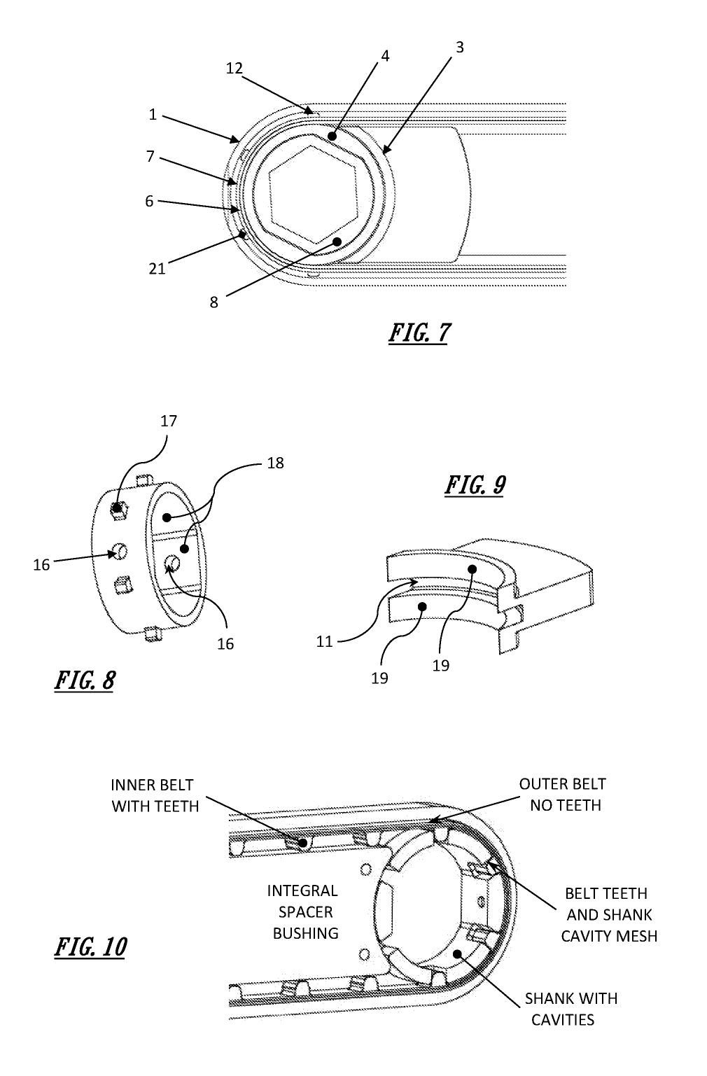

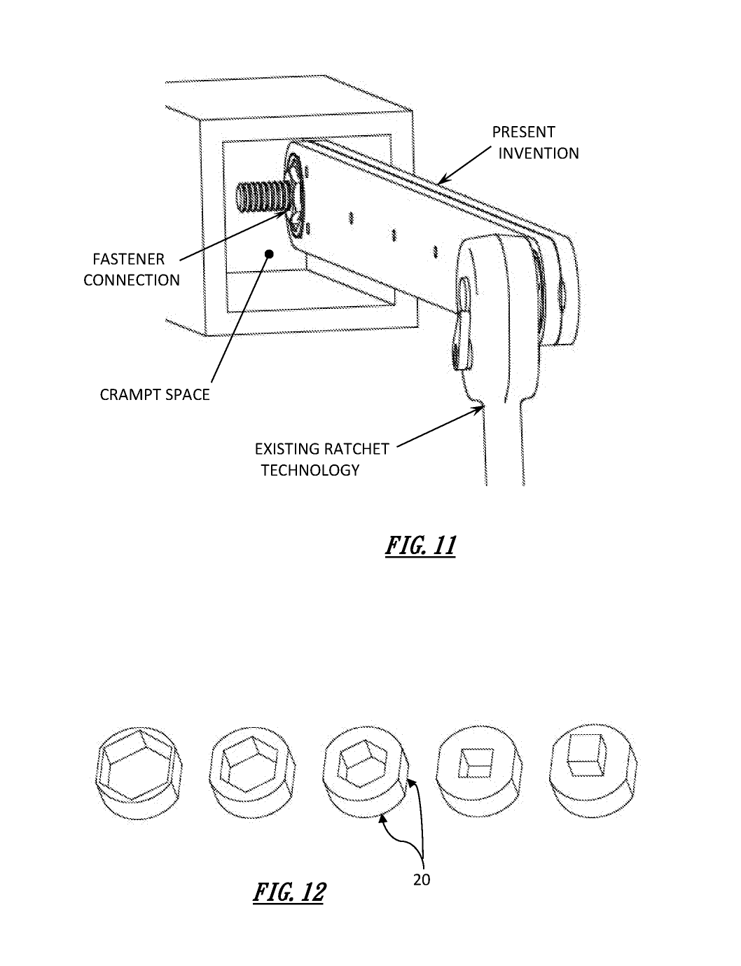

Now with reference to drawings, the device is a double aperture wrench having a long narrow split shelled casing with semicircular ends and containing two apertures at each end as shown in FIG. 1. This long narrow body is symmetric in all planes originating from the centroid of the device. The said long narrow body is a housing that is structurally composed of two identical shelled parts 1 and a stiffening spacer 2. Assembly of housing can be of any form as in being fastened, riveted, welded or the like of which is not detailed in figures. The said housing contains identical bushings 3 that are constrained to the apertures by shaped geometry 9 and directly contacts stiffening spacer 2 on both ends in housing shell as shown in FIG. 3. The bushing positioning is strategically placed for friction and load support hence supplying smooth load bearing surfaces 19 and providing an unimpeded rotatable shank rotation when the device is transferring high torques. The combined aforementioned designs help in a non-collapsing system whereby high tensile loads resulting from applied high torques tend to draw the opposing rotatable shanks together. The resulting circular apertures 10 nest identical rotatable shanks 4 that are side-to-side controllably constrained by the channel feature 11 in the bushing and radial protrusions 12 on rotatable shanks 4 and are allowed to freely rotate in the apertures at each end as shown in FIG. 5. The two rotatable shanks 4 are connected by the torque transfer means 6,7. The said torque transfer means 6,7 is a plurality of thin flexible high tensile strength metal bands each surrounding the other 14 in a tightfitting fashion. The plurality of bands 14 can be any amount required to meet a torque transfer design performance requirement hence the first endless band is encased by the second and a third and so on- to recite that each encased fit is snug to the former. Any metal or composite combination of metals and non-metals can be design engineered for use however the stainless steel types performed best in the present invention as shown in FIG. 2. As per FIG. 4, the mechanics of torque transfer 15 occurs from the interaction of the protrusions 12 on the rotatable shank's outer circumferential surface and openings 13 in belts 6,7. The mechanisms of torque transfer can be shape and pitch engineered (number of protrusion and opening engagement per belt length) to a specific performance however a rectangular profile 17 shown in FIG. 8 tested best in overall performance for the present invention. Clearly it can be realized that the present invention's torque transfer means 6,7 provides for the most compact design against the majority of prior arts containing chains and wire loops with rollers and the likes. The rotatable shank's 4 protrusions 12 are also design with close tolerance 21 to the casing 1 as to prevent engagement issues occurring from wear, stretch, and abnormal tool use. The rotatable shank 4 is designed to accept inserts/adapters 8 as shown in FIG. 12 and these are retained by magnetism. Said magnetism is produced by implanting strong small magnets 5 into openings 16 in rotatable shank 4. Another method can be magnetizing material if material permits. Synchronized rotation of the rotatable shank 4 and insert/adapter 8 is achieved from matching geometry on both the rotatable shank center 18 and the insert/adapter outer surface 20. Said geometry can vary however the functionality and purpose must remain the same. References herein are to details of the illustrated embodiments and are not intended to limit the scope and use of the invention FIG. 10,11,12 to which themselves recite those features regarded as essential to the invention. There exist patented inventions of this form but none appears to have the matched capability of transferring the high force/torque requirements in a comparable design package as the present invention does. During the development of the invention the inventors of the present invention verified these issues by investigating the driving mechanisms that exist in the prior arts. These mechanisms exist as drive trains in the form of multiple gear types, chains loops, and the likes. To achieve a competing design as in the present invention these components will be large and bulky, thereby making the prior devices inferior. See FIG. 10, an off-shoot device that was produced and tested. It was inversely designed, whereby the rotatable shank had the cavities and the inner band contained teeth for torque transfer. In this configuration the outer band is smooth and is fused at strategic points to the inner band whereby both bands behave as one when in tensile load. This design worked well but proved to be more costly to develop and produce. The design goals of the present invention pursued implementing tool design criteria's as per 25.140.30-ISO and Machinery's Handbook. Hence the said compact housing is very close to the dimensional footprint and of a ratcheting box wrench and the likes. Said present invention is scalable in design for variable torque range grouping a feature that is concurrent to hand tool sizing designs for specified torque range. The present invention's design permits the ability to overdesign in a still compact package for the most stubborn fastener connections such as rusted, galled, fused, and like difficult situations. The current design also offers the ability to produce a device that can transfer high torque over a long distance (a highly elongated device) without a large cost change. All of the aforementioned prior arts challenges and many more have been resolved by the present invention. Therefore the invention is both innovative and an improvement on similar tools and devices existing in prior arts.

What is claimed is:

1. A torque transfer driver device that is symmetric in all planes and can be reversibly operated in the same comprising:
a) semi-circular ends, protracted, slim and narrow split shelled housing with a full central stiffener and combined by fasteners, welds, or the likes.
b) concentric identical apertures at both ends with means of entrapping identical bushing and identical rotatable shank.
c) encasing plurality of flexible endless high tensile strength torque transfer means in communication with both rotatable shanks, said communication is in the form of a plurality of equally spaced protrusions on rotatable shank and a matching spaced array of openings along full length in torque transfer means.
d) centered geometric opening in rotatable shank wherein the internal faces of the opening contains implanted magnets for retention of insert type sub-components and the likes thereof.
e) said sub-components contain outer geometry matching rotatable shank's opening as to produce synchronize rotation when inserted and engaged.
f) said sub-components contain inner geometry matching driving tools such as; driving handles, ratcheting handles and powered tools to include driven devices such as; wrench sockets, screw driver bits, hex bits and the likes.

2. A torque transfer driver device as narrated in claim 1, in which the central stiffener can be an integral design of the shelled exterior in the form of ribs and the likes.

3. A torque transfer driver device as narrated in claim 1, having superior performance type bushings positioned between rotatable shanks at either end of protracted housing and in contact with rotatable shanks, whereby handling the large loads produced by the torque transfer means during high tensions from applied forces.

4. A torque transfer driver device as narrated in claim 3, wherein grease type lubricants are a consideration when device is continuously operated as such by powered tools.

5. A torque transfer driver device as narrated in claim 3, containing two identical hollow rotatable shanks demonstrating a plurality of equally spaced, radial protrusions, each having a slightly elongated cube like appearance and rounded on all sharps and corners.

6. A torque transfer driver device as narrated in claim 3, having a torque transfer means composed of an encasing plurality of thin flexible endless bands each having a matching lengthwise pitch array of geometrically accepting opening per geometry of radial protrusions on the rotatable shanks.

7. A torque transfer driver device as narrated in claim 6, wherein the main objective of the torque transfer means is to provide a tool with the best performance in a minimum footprint whereas the plurality, thinness, width and flexibility of the band can be exactly calculated and engineered for a specific tool or device requirement.

8. A torque transfer driver device as narrated in claim 6, whereby endless bands are made with high tensile strength metals and related composites both metals and non-metals.

9. A torque transfer driver device as narrated in claim 8, wherein metals of the Stainless Steel, 300 Series, has provided the best test results in both production and cost.

10. A torque transfer driver device as narrated in claim 5, wherein the rotatable shanks contain hollow centered geometry to accept inserts and adapters.

11. A torque transfer driver device as narrated in claim 10, wherein the rotatable shank inner geometry and the insert or adapter outer geometry are engineered to produce rotatable torque transfer and non-deformation while enduring enormous forces from process.

12. A torque transfer driver device as narrated in claim 5, wherein the rotatable shanks contain implanted magnets to retain inserts and adapters.

13. A torque transfer driver device as narrated in claim 10, wherein the inserts and adapters are designed to assimilate with current hand and power tool accessories.

14. A torque transfer driver device as narrated in claim 1, whereby the torque transfer device can be a parent device to its own family of inserts and adapters. Similarly to the likes of a ratchet driver and socket tool set.

15. A torque transfer driver device as narrated in claim 1, whereby the torque transfer means and the rotatable shank are inversely designed.

16. A torque transfer driver device as narrated in claim 15, whereby the rotatable shanks contains a plurality of equally spaced, radial openings.

17. A torque transfer driver device as narrated in claim 15, whereby the torque transfer means is composed of an encasing plurality of thin flexible endless bands fused together at strategic points as to behave as one during tensile loading.

18. A torque transfer driver device as narrated in claim 15, wherein the torque transfer means innermost band is one containing an array of equally spaced teeth along its endless length matching openings of rotatable shank.

19. A torque transfer driver device as narrated in claim 15, where torque transfer occurs from meshing of the openings in rotatable shank and the teeth of innermost band of the said torque transfer means.
